(19) United States
(12) Patent Application Publication
(10) Pub. No.: US 2008/0104458 A1
(43) Pub. Date: May 1, 2008

(54) Semiconductor memory, system, testing method for system

(75) Inventor: Toshiya Uchida, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/907,996

(22) Filed: Oct. 19, 2007

Related U.S. Application Data
(63) Continuation of application No. PCT/JP05/07646, filed on Apr. 21, 2005.

(51) Int. Cl. G06F 11/277

(52) U.S. Cl. 714/719; 714/718; 714/E11.175

(57) ABSTRACT

A plurality of test patterns generated by a test pattern generator is output from a first memory chip to test a second memory chip, which is of a different type from the first memory chip and mounted in the same package. Therefore, when different types of memory chips are mounted in the same package, the memory chip is tested even no terminal of the memory chip is connected to an external terminal of a system. Since there is no need to form any useless terminal in the system, system cost is reduced. Since a testing apparatus generating complicated test patterns is made unnecessary, test cost is reduced. The test pattern generator is constructed using nonvolatile logic and therefore, tests can be carried out without preparing test patterns in advance. Consequently, a user who purchases the first and second memory chips to construct a system can also carry out tests easily.

### CROSS-REFERENCE TO RELATED APPLICATION

This application is a Continuation Application of International Application No. PCT/JP2005/007646, filed Apr. 21, 2005, designating the U.S.

### BACKGROUND

1. Field

The present invention relates to a testing technology for a system configured by mounting a plurality of types of semiconductor memory chips in one package.

2. Description of the Related Art

In recent years, a technology called SiP (System in Package) or MCP (multi-chip package) to configure a system by housing a plurality of types of memory chips and logic chips whose processing technologies are different from each other in one package has been developed. Also, a technology called SoC (System on chip) to configure a system by integrating a plurality of types of memory circuits and logic circuits on one chip has been developed.

In such types of system (for example, SiP), an external terminal is formed for signals that need to be input/output from/to the outside and is not formed corresponding to all terminals (pads) of memory chips and logic chips. Particularly a memory chip is often accessed only by logic chips and thus, a memory chip terminal is only infrequently connected to an external terminal. A special testing technology is needed to test a memory chip not connected to an external terminal of MCP. Japanese Unexamined Patent Application Publication No. 2003-77296, for example, discloses an MCP in which a test circuit to test memory chips is formed within a logic chip. Japanese Unexamined Patent Application Publication No. 2003-149300 and Japanese Unexamined Patent Application Publication No. 2001-325800 disclose a technology to cause a memory circuit to function as programmable logic to configure a test circuit test and test other memory circuits. Programmable logic is configured by reading circuit data from outside a system.

SiPs and MCPs are often assembled by a semiconductor manufacturer or a user who purchased chips from the semiconductor manufacturer. When a user assembles a SiP or MCP, tests after assembling must be performed by the user. SoCs, on the other hand, are exclusively manufactured by manufacturers and therefore, tests after completing SoCs are performed by manufacturers.

When a manufacturer tests a system such as an MCP and SiP in which a plurality of types of semiconductor memory chips is mounted, the manufacturer can use test patterns to test single memory chips as test patterns for memory chips mounted in the system. Also when a test circuit such as a test pattern generator is configured by programmable logic, existing test patterns for single memory chips can be used.

When, on the other hand, a user who purchased memory chips assembles a system such as an MCP and SiP and tests the system, the user needs to acquire test patterns from a manufacturer or create such test patterns on his (her) own. When a manufacturer offers test patterns to a user, an outflow of testing technology could occur. Further, if the user could acquire test patterns, a testing apparatus to provide the test patterns to memory chips is needed. Test patterns to test memory chips are generally complicated and it is necessary to use an LSI tester (memory tester) for memory to test memory chips. In this case, the user must purchase an expensive LSI tester.

If a logic chip is mounted in an MCP or SiP, an LSI tester (logic tester) to test the logic chip is needed. If the user should have both the memory tester and logic tester, tests must be performed by alternately setting the MCP or SiP to the memory tester and logic tester, decreasing test efficiency.

Further, if the user configures logic of programmable logic in a memory chip, logic data needs to be obtained from a manufacturer to keep down test costs. However, it is difficult for the manufacturer to distribute logic data to all users who assemble a system such as an MCP and SiP in view of time and costs. Moreover, since logic data needs to be written to programmable logic each time a test is carried out, the test time and test costs of a system increase. Therefore, it is not realistic to test a system such as an MCP and SiP using programmable logic in the memory chip.

### SUMMARY

An object of the present invention is to reduce test costs of a system in which a plurality of types of memory chips is mounted in one package.

In an aspect of the present invention, a test pattern generator of a semiconductor memory (first memory chip) generates a plurality of test patterns. Test patterns are output from a plurality of external output terminals of the first memory chip to test a different type of memory chip (second memory chip) mounted in the same package as the first memory chip. Then, not only a memory cell array of the first memory chip, but also the second memory chip is tested by the test patterns. Therefore, if different types of memory chips are mounted in the same package and even when no terminal of the memory chip is connected to an external terminal of a system, the memory chip can be tested. Since the system does not need to form a useless external terminal, system costs can be reduced. Also, since no testing apparatus to generate complicated test patterns is needed, test costs can be reduced.

In contrast to programmable logic, a test pattern generator is configured using nonvolatile logic. Thus, there is no need to read circuit data of the test pattern generator before a test. Since a test can be carried out without preparing test patterns in advance, a user who purchases the first and second memory chips to configure a system can also carry out a test easily. That is, test costs can be reduced.

In another aspect of the present invention, an external input terminal of the first memory chip receives test patterns read from the second memory chip. A comparator compares test patterns generated by a test pattern generator and those received by the external input terminal. A comparison result by the comparator is output from a test result terminal. Thus, whether the second memory chip operates or not can be determined within the first memory chip before being output to the outside. For example, since a test result can be obtained by determining a logical level of the test result terminal, a test can be carried out by a simple testing apparatus.

In another aspect of the present invention, a test control terminal of the first memory chip receives a test control signal to control operations of a pattern generator. For example, test patterns generated to be written into the first and second memory chips are determined in accordance with the test control signal. Thus, the first and second memory chips can reliably be tested using various test patterns by means of external control. It is possible not only to carry out a simple pass/fail test, but also to carry out a detailed margin test.

In another aspect of the present invention, a system in which the first and second memory chips are mounted has a logic chip mounted to access these memory chips. The system has a system bus that mutually connects the first memory chip, second memory chip, and logic chip. External output terminals of the first memory chip are connected to the system bus. Since test patterns can be written into the second memory chip using the system bus to operate the system, the number of wires in the system can be reduced and thus, system costs can be reduced. Also, by testing the second memory chip, an interconnection test of the system bus can be carried out.

In another aspect of the present invention, a logic-test result input terminal of a logic chip is connected to a test result terminal of the first memory chip to receive a comparison result from the first memory chip. Thus, test costs can be reduced by causing the logic chip to operate as a testing apparatus to test the first and second memory chips.

In another aspect of the present invention, a logic chip has a logic-test result output terminal to output a comparison result received by a logic-test result input terminal to the outside of a system. A selector of the logic chip outputs a comparison result received by the logic-test result input terminal to the logic-test result output terminal when an internal circuit of the logic chip does not operate and at least one of the first and second memory chips is tested. The selector also outputs a signal received by the logic-test result input terminal to the internal circuit of the logic chip when the internal circuit of the logic chip operates. Thus, the comparison result (test result) not only is supplied to the logic chip, but also can be output to the outside of a system. Therefore, optimal tests in accordance with a test environment of a user developing a system can be carried out. More specifically, if the user has only a simple testing apparatus, for example, a comparison result can be determined by the logic chip. If the user has a testing apparatus such as an LSI tester, a comparison result can be determined by the LSI tester. Further, when the logic chip is mounted in another system, the logic-test result input terminal and logic-test result output terminal can be used as terminals for other functions.

In another aspect of the present invention, a logic chip is connected to a test control input terminal of the first memory chip and has a logic-test control output terminal to output a test control signal. Thus, the logic chip can be operated as a testing apparatus to test the first and second memory chips. As a result, test costs can be reduced.

In another aspect of the present invention, a logic chip has a logic-test control input terminal to receive a test control signal to be output to a logic-test control output terminal from outside a system. A selector of the logic chip outputs a test control signal received by the logic-test control input terminal to the logic-test control output terminal when an internal circuit of the logic chip does not operate and at least one of the first and second memory chips is tested. The selector also outputs a signal received by the logic-test control input terminal to the internal circuit of the logic chip when the internal circuit of the logic chip operates. Thus, the test control signal not only is output from logic chip, but also can be supplied from outside the system. Therefore, optimal tests in accordance with a test environment of a user developing a system can be carried out. More specifically, if the user has only a simple testing apparatus, for example, a test can be carried out by causing the logic chip to output a test control signal. If the user has a testing apparatus such as an LSI tester, a test can be carried out by causing the LSI tester to output a test control signal. Further, when the logic chip is mounted in another system, the logic-test control output terminal and logic-test control input terminal can be used as terminals for other functions.

In another aspect of the present invention, a system bus includes a system signal line closed within a system and through which a signal output/input from/into a logic internal terminal of a logic chip to access the first and second memory chips. The logic chip has a logic external terminal to connect a logic internal terminal to the outside of a system. A selector of the logic chip connects the system signal line to the logic external terminal when an internal circuit of the logic chip does not operate and at least one of the first and second memory chips is tested. The selector also connects the system signal line to the internal circuit when the internal circuit of the logic chip operates. Thus, a signal for accessing the first and second memory chips not only is caused to be input/output into/from the logic chip, but also can be input from outside the system or output to the outside of the system. Therefore, the first and second memory chips can be tested in more detail using a testing apparatus. If, for example, one of the first and second memory chips is a semiconductor memory that can electrically be rewritable, a program or the like can be written into the semiconductor memory using the testing apparatus.

### BRIEF DESCRIPTION OF THE DRAWINGS

FIG. 1 is a block diagram showing a first embodiment;

FIG. 2 is a block diagram showing a second embodiment;

FIG. 3 is a block diagram showing a third embodiment;

FIG. 4 is a block diagram showing a fourth embodiment;

FIG. 5 is a block diagram showing a fifth embodiment;

FIG. 6 is a block diagram showing a sixth embodiment;

FIG. 7 is a block diagram showing a seventh embodiment;

FIG. 8 is a block diagram showing an eighth embodiment;

FIG. 9 is a block diagram showing a ninth embodiment;

FIG. 10 is a block diagram showing a tenth embodiment;

FIG. 11 is a block diagram showing an eleventh embodiment;

FIG. 12 is a block diagram showing a twelfth embodiment;

FIG. 13 is a block diagram showing a thirteenth embodiment;

FIG. 14 is a block diagram showing a fourteenth embodiment; and

FIG. 15 is a block diagram showing a fifteenth embodiment.

### DETAILED DESCRIPTION OF THE EMBODIMENTS

Embodiments will be described below with reference to drawings. A double square symbol in figures designates an external terminal (pad) formed on a chip. A triple square symbol in figures designates an external terminal (lead or bump) of an MCP or SiP. A signal line shown in a thick line in figures is configured by a plurality of wires. Some blocks to which a thick line is connected are configured by a plurality of circuits. The same symbol as a terminal name is used for a signal supplied via the external terminal. Also, the same symbol as a signal name is used for a signal line through which the signal is transmitted. In the following embodiments, a package in which only a plurality of memory chips is mounted is called an MCP and a package in which memory chips and a logic chip are mounted is called a SiP.

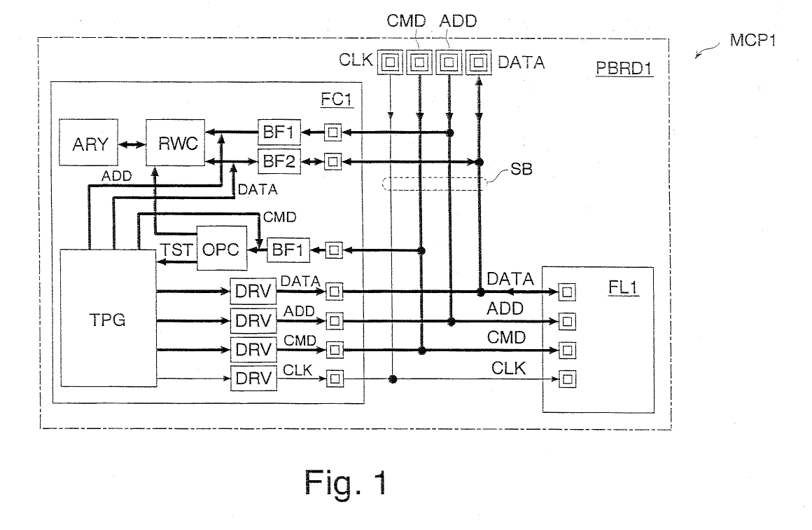

FIG. 1 shows a first embodiment. In this embodiment, an FCRAM chip FC1 (Fast Cycle RAM: first memory chip) and a flash memory chip FL1 (second memory chip) are mounted on a package board PBRD1 to form a multi-chip package MCP1 (system). The MCP1 is mounted, for example, in portable equipment such as a mobile phone. The FCRAM chip FC1 has a DRAM memory core and is a kind of pseudo SRAM chip having an SRAM interface. The FCRAM chip FC1 operates asynchronously with a clock and the flash memory chip FL1 operates synchronously with a clock. The FCRAM chip FC1 and the flash memory chip FL1 are also called a chip FC1 and a chip FL1 respectively below.

The chip FC1 has a memory cell array ARY having volatile memory cells (dynamic memory cells), a read/write control circuit RWC, a plurality of buffers BF1 and BF2, an operation control circuit OPC, a test pattern generator TPG, a plurality of drivers DRV, and a plurality of pads. The read/write control circuit RWC receives during write operation an address ADD and data DATA supplied via the pad and the buffer BF1, BF2 and writes the data DATA to a memory cell denoted by the address ADD. Also, the read/write control circuit RWC reads during read operation data DATA from a cell memory denoted by an address ADD and outputs the read data DATA to a pad via the buffer BF2. The buffer BF2 also has a function as a driver to output the data DATA to the outside of the chip FC1.

In accordance with a command CMD supplied via the pad and the buffer BF1, the operation control circuit OPC outputs an operation control signal for accessing the memory cell array ARY to the read/write control circuit RWC. Also, the operation control circuit OPC outputs a test signal TST for activating the test pattern generator TPG when the command CMD supplied from outside the package board PBRD1 indicates a test command. With an output of the test signal TST, the chip FC1 changes its state from a normal operation mode to a test mode. The chip FC1 changes its state from the test mode to the normal operation mode when the command CMD indicating a test end is supplied to the chip FC1 from outside of package board PBRD1.

The test pattern generator TPG generates test patterns (CMD, ADD, and DATA) for the chip FC1 successively in predetermined timing to output the generated test patterns to the read/write control circuit RWC when the test signal TST indicates a test of the chip FC1. When the test signal TST indicates a test of the chip FL1, the test pattern generator TPC generates test patterns (CMD, ADD, DATA, and CLK) for the chip FL1 successively in predetermined timing to output the generated test patterns to the chip FL1 via the driver DRV, pad (external output terminal), and system bus SB. The system bus SB is used, as described above, not only when accessing the chip FC1 or FL1 from outside the MCP1, but also when testing the chip FL1 using the circuit of the chip FC1. Logic of the test pattern generator TPG is configured by nonvolatile logic (hardware whose logic is fixed) such as a gate circuit. Thus, after power is supplied to the MCP1, the test pattern generator TPG can immediately generate test patterns without loading data for configuring logic such as program logic.

In the present embodiment and embodiments that follow, the operation control circuit OPC may also output a common test signal TST after receiving a test command common to the chips FC1 and FL1. In this case, when the test signal TST is received, the test pattern generator TPG successively generates test patterns to test the chips FC1 and FL1 to successively test the chips FC1 and FL1.

The flash memory chip FL1 is, for example, a NOR type and terminals excluding the clock terminal are compatible with terminals of the FCRAM chip FC1 (SRAM). The package board PBRD1 is, for example, a printed-wiring board. The system bus SB connected to the chips FC1 and FL1 and external terminals (leads or bumps) for inputting/outputting signals into/from the system bus SB are formed on the package board PBRD1. Though not shown, a plurality of pads for connecting pads of the chips FC1 and FL1 and the system bus SB by a bonding wire or bump is also formed on the package board PBRD1. If the external terminal of the package board PBRD1 is a lead, the pads of the chips FC1 and FL1 and a lead frame may also be connected directly by a bonding wire. In this case, the system bus SB is configured by the bonding wire and therefore, the package board PBRD1 may not be a printed-wiring board. A controller (for example, a CPU) connected to the MCP1 accesses the chip FC1 or FL1 via the external terminals of the MCP1.

In the present embodiment, for example, a manufacturer (user) developing portable equipments purchases the FCRAM chip FC1 and the flash memory chip FL1 from a semiconductor manufacturer to assemble the MCP1. After assembling (packaging) the MCP1, the manufacturer of portable equipments performs an operation test of the MCP1 using a simple testing apparatus. More specifically, the chip FC1 moves to the test mode by a test command being supplied from the testing apparatus to the MCP1 before test data is written into the chip FC1 and the chip FL1. Write data patterns to test are made public by the semiconductor manufacturer. Here, write data patterns are publicly known test data writing order and maps of data to be written such as all zero patterns, all one patterns, and marching patterns. The testing apparatus accesses the memory cell array ARY of the chip FC1 and the memory cell array of the chip FL2 to obtain a test result and compares read data with write data patterns (expected values) made public by the semiconductor manufacturer to determine whether the MCP1 is a good product or a bad one.

The testing apparatus can generate a test command and, if specified to be able to access the chips FC1 and FL1, can test the MCP1. Thus, a testing apparatus (for example, a memory dedicated LSI tester (memory tester)) that generates complicated test patterns (including signal timing) is not needed. A frequency used for accessing the chip FC1 or FL1 to obtain a test result may be low. Since the MCP1 can be tested by a simple testing apparatus, test costs can be reduced. In addition, there is no need to load data to configure logic of the test pattern generator TPG.

Particularly, since the manufacturer of portable equipment purchasing the chips FC1 and FL1 to manufacture the MCP1 does not need to purchase an expensive LSI tester and the like, test costs can significantly be reduced. Further, there is no need to obtain detailed test patterns including timing (or logic data for generating logic generating test patterns) from the manufacturer. Since the manufacturer does not need to present detailed test patterns to customers, an outflow of testing technology can be prevented.

In the first embodiment, as described above, the test pattern generator TPG is formed in the chip FC1 for generating test patterns to test the memory cell array of the chip FL1 that is a different types of the memory cell array ARY of the chip FC1. Thus, test data can be written into the chips FC1 and FL1 without using an expensive testing apparatus for generating complicated test patterns. As a result, test costs of the MCP1 can be reduced.

Since test patterns can be supplied to the chip FL1 using the system bus SB when testing the chip FL1, the number of wires (or the number of bonding wires) formed on the package board PBRD1 can be reduced, decreasing the size of the package board PBRD1.

In contrast to programmable logic, the test pattern generator TPG is formed using nonvolatile logic (hardware). Thus, there is no need to read circuit data for configuring the test pattern generator TPG before a test. Since a test can be carried out without preparing test patterns in advance, a user who purchases the chips FC1 and FL1 to assemble the MCP1 can also carry out a test of the chips FC1 and FL1 easily after assembling the MCP1.

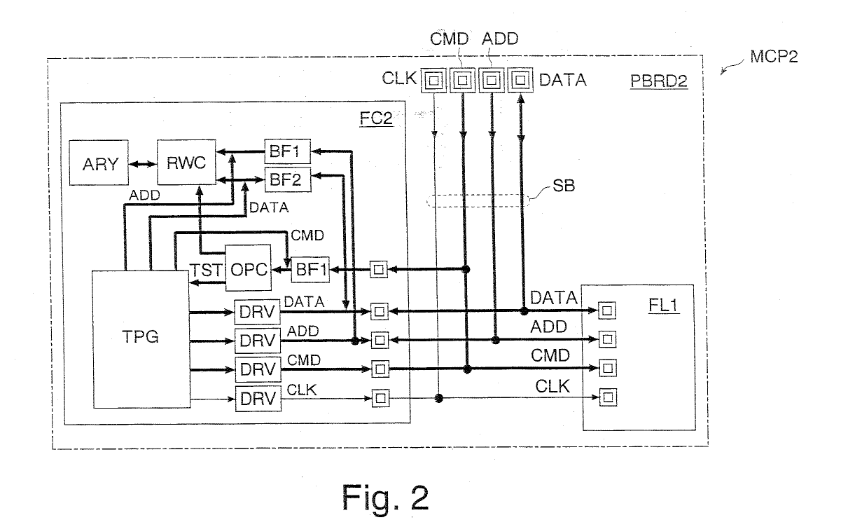

FIG. 2 shows a second embodiment. The same symbols are attached to the same components as those in the first embodiment to omit a detailed description thereof. In this embodiment, an FCRAM chip FC2 and the flash memory chip FL1 are mounted on a package board PBRD2 to form a multi-chip package MCP2 (system). The MCP2 is mounted, for example, in portable equipment such as a mobile phone. The package board PBRD2 is the same as the package board PBRD1 in the first embodiment except that connection specifications (bonding specifications) between the external terminals (leads or bumps) and pads of the chips FC1 and FL1 are different.

The chip FC2 has pads (external terminals) common to a signal input for accessing the memory cell array ARY and a test pattern signal output to the chip FL1. However, command terminals CMD are formed independently for the chip FC2 and for the chip FL1 test. Otherwise, the chip FC2 is the same as the chip FC1 in the first embodiment.

In this embodiment, write data DATA to the memory cell array ARY is supplied to the buffer BF2 via a common pad. Data DATA read from the memory cell array ARY is output to an external terminal of the package board PBRD2 via the buffer BF2 and the common pad. The address ADD for accessing the memory cell array ARY is supplied to the buffer BF1 via the common pad.

A technique used to test the MCP2 in the present embodiment is the same as that in the first embodiment. That is, when a test command is received from outside the MCP2, the chip FC2 writes test data to the chip FC2 (memory cell array ARY) and the chip FL1. After the data is written, a testing apparatus to test the MCP2 determines whether the MCP2 is a good product or a bad one by reading test data stored in the chips FC2 and FL1.

Also in the second embodiment, as described above, an effect similar to that of the first embodiment can be obtained. Further, in the present embodiment, common pads for signals ADD and DATA input/output into/from the chip FC2 to access the memory cell array ARY and for outputting test patterns (ADD and DATA) generated by the test pattern generator TPG are formed in the chip FC2 and therefore, the number of pads formed in the FC2 can be reduced, decreasing the size of the chip FC2.

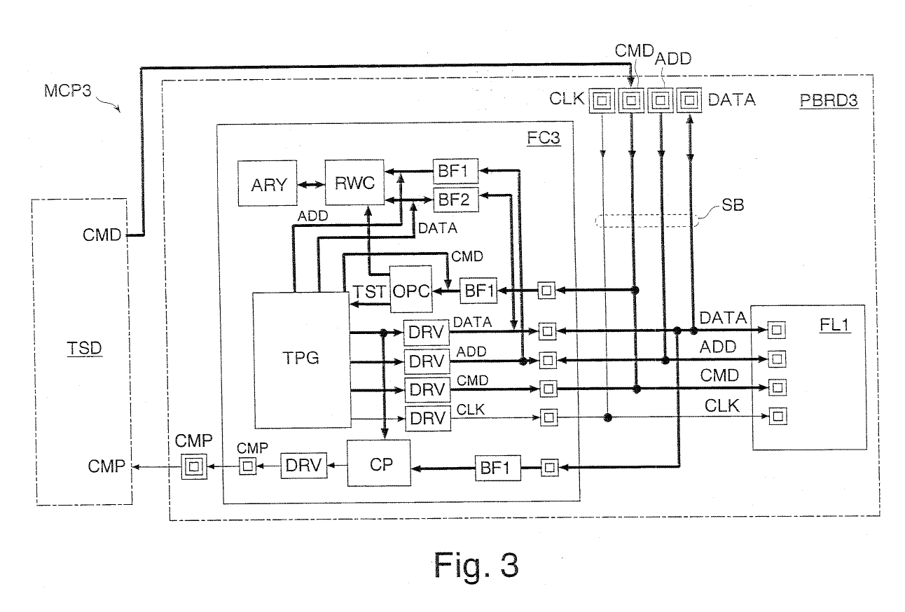

FIG. 3 shows a third embodiment. The same symbols are attached to the same components as those in the first and second embodiments to omit a detailed description thereof. In this embodiment, an FCRAM chip FC3 and the flash memory chip FL1 are mounted on a package board PBRD3 to form a multi-chip package MCP3 (system). The MCP3 is mounted, for example, in portable equipment such as a mobile phone.

The chip FC3 has, in addition to the configuration of the chip FC2 in the second embodiment, pads (external input terminals) connected successively, the buffer BF1, a comparator CP, the driver DRV, and the test result terminal CMP (pad). The comparator CP compares test write data for the chip FL1 output from the test pattern generator TPG and test read data read from the chip FL1 into which the test write data has been written via the buffer BF1, and outputs a comparison result to the test result terminal CMP via the driver DRV. The test result terminal CMP is a dedicated terminal for outputting a test result signal CMP indicating the test result.

The package board PBRD3 is the same as the package board PBRD2 in the second embodiment except that pattern wiring and connection specifications (bonding specifications) are different to connect a data line DATA of the system bus SB to a pad corresponding to the comparator CP and a test result terminal CMP (a system-test connection terminal, lead, or bump) is provided.

In the present embodiment, a testing apparatus TSD is connected to the MCP3 in a test after manufacturing the MCP3. More specifically, for example, a test is carried out after the MCP3 is mounted to an IC socket of an evaluation board of the testing apparatus TSD to determine whether the MCP3 is a good product or a bad one. Since at this time a clock CLK, an address ADD, and data DATA needed for the test are generated by the test pattern generator TPG, a clock terminal CLK, an address terminal ADD, and a data terminal DATA of the package board PBRD3 are set in an open position.

The testing apparatus TSD outputs a test command CMD to a command terminal CMD and receives a test result (comparison result) via the test result terminal CMP. The testing apparatus TSD needs only to start a test and receive a test result. Thus, the testing apparatus TSD can be configured by a simple logic circuit. Also, by mounting many IC sockets on the evaluation board of the testing apparatus TSD, many MCP3 can be tested at a time. In this case, tests of a plurality of MCP3's may be started simultaneously and therefore, a test command signal line CMD formed on the evaluation board can be made common to a plurality of MCP3's.

Also in the third embodiment, as described above, an effect similar to that of the above embodiments can be obtained. Further, the test result terminal CMP is formed on the chip FC3 and the package board PBRD3 in the present embodiment and therefore, the testing apparatus TSD can determine whether the MCP3 is a good product or a bad one based solely on a test result transmitted to the test result terminal CMP without reading data from the chips FC1 and FL1. Thus, the testing apparatus TSD can be configured by a simple circuit. As a result, test costs can be reduced.

Further, also when many MCP3's are mounted on the evaluation board, signals required for the testing apparatus TSD are only the test command signal CMD common to a plurality of MCP3's and the test result signal CMP required for each MCP3. Many MCP3's can be tested at a time due to the simple testing apparatus TSD and therefore, the test time and test costs can significantly be reduced.

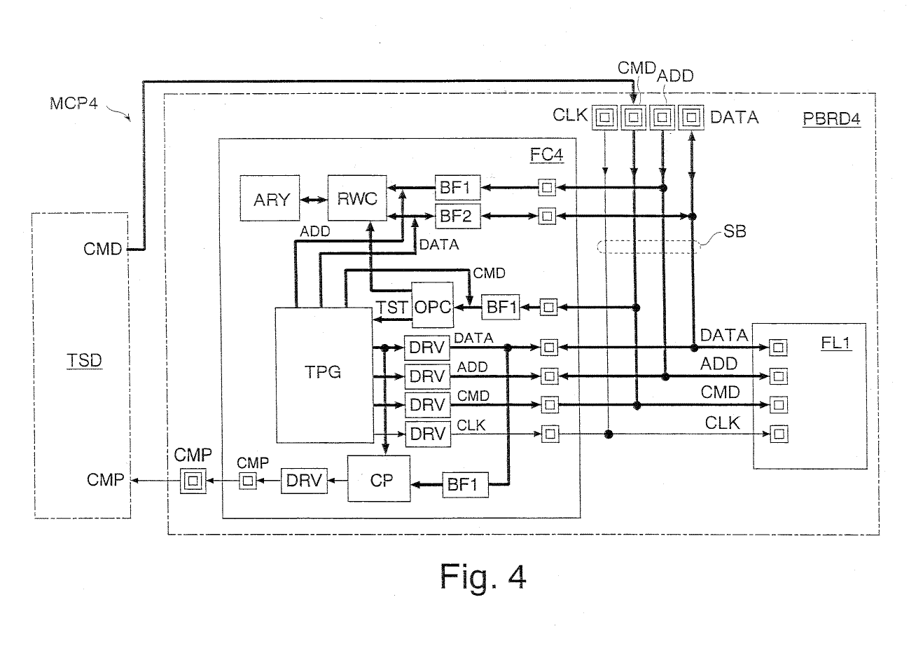

FIG. 4 shows a fourth embodiment. The same symbols are attached to the same components as those in the above embodiments to omit a detailed description thereof. In this embodiment, an FCRAM chip FC4 and the flash memory chip FL1 are mounted on a package board PBRD4 to form a multi-chip package MCP4 (system). The MCP4 is mounted, for example, in a portable equipment such as a mobile phone.

The chip FC4 has, in addition to the configuration of the chip FC1 in the first embodiment, pads (external input terminals) connected successively, the buffer BF1, the comparator CP, the driver DRV, and the test result terminal CMP (pad). The package board PBRD3 has, in addition to the package board PBRD1 in the first embodiment, the test result terminal CMP (an external output terminal such as a lead and bump). Also in the fourth embodiment, as described above, an effect similar to that of the above embodiments can be obtained.

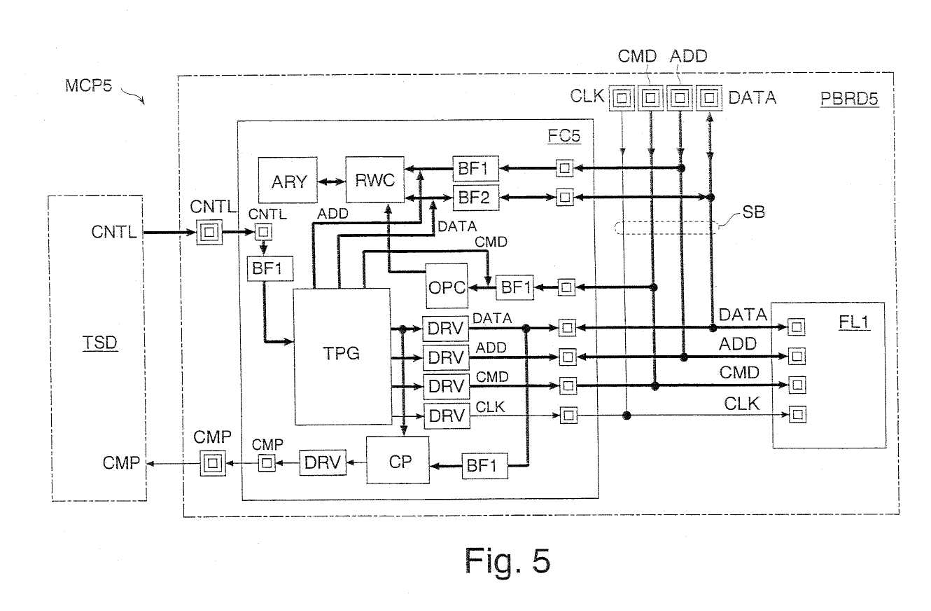

FIG. 5 shows a fifth embodiment. The same symbols are attached to the same components as those in the above embodiments to omit a detailed description thereof. In this embodiment, an FCRAM chip FC5 and the flash memory chip FL1 are mounted on a package board PBRD5 to form a multi-chip package MCP5 (system). The MCP5 is mounted, for example, in a portable equipment such as a mobile phone.

The chip FC5 has, in addition to the configuration of the chip FC4 in the fourth embodiment, a test control terminal CNTL (pad) for receiving a test control signal CNTL and the buffer BF1. The test control signal CNTL is input, instead of the test command CMD in the above embodiments, into the test pattern generator TPG. The test control terminal CNTL is a dedicated terminal for receiving only the test control signal CNTL.

The test pattern generator TPG generates test patterns to test the memory cell array ARY of the chip FC5 or the chip FL1 in accordance with the logical level of the test control signal CNTL. That is, the test control signal CNTL is supplied to the test pattern generator TPG in order to control operations of the test pattern generator TPG and select a plurality of types of test patterns generated by the test pattern generator TPG. The type of operation test (test pattern) is changed, for example, in accordance with the logical level of the test control signal CNTL configured by a plurality of bits. Thus, any test such as all-zero, all-one, a marching test, or a galloping test can freely be carried out in accordance with the test control signal CNTL.

The package board PBRD5 is the same as the package board PBRD4 in the fourth embodiment except that a test control terminal CNTL (a system-test control terminal, lead, or bump) is provided.

In the present embodiment, like the third embodiment, in a test after manufacturing the MCP5, an operation test is carried out by connecting the testing apparatus TSD to the MCP5. At this time, the testing apparatus to test the MCP5 outputs a test control signal CNTL having logic in accordance with test specifications to the MCP5. In response to the test control signal CNTL, the test pattern generator TPG starts output of predetermined test patterns. Thus, by using the test control signal CNTL, it becomes possible not only to carry out a simple pass/fail test, but also to carry out a detailed margin test. The testing apparatus TSD receives a test result via the test result terminal CMP. The clock terminal CLK, command terminal CMD, address terminal ADD, and data terminal DATA are not used during a test and therefore, they are set in an open position.

Also in the fifth embodiment, as described above, an effect similar to that of the above embodiments can be obtained. Further, in the present embodiment, the number of terminals required for tests can be reduced. Therefore, the number of MCP5 mounted on an evaluation board of the testing apparatus TSD when a plurality of MCP5 are simultaneously tested can be increased, further reducing the test time and test costs. Since the test control signal CNTL for selecting test patterns can be supplied from outside the MCP5, the chips FC5 and FL1 can be tested in detail using various test patterns by means of external control.

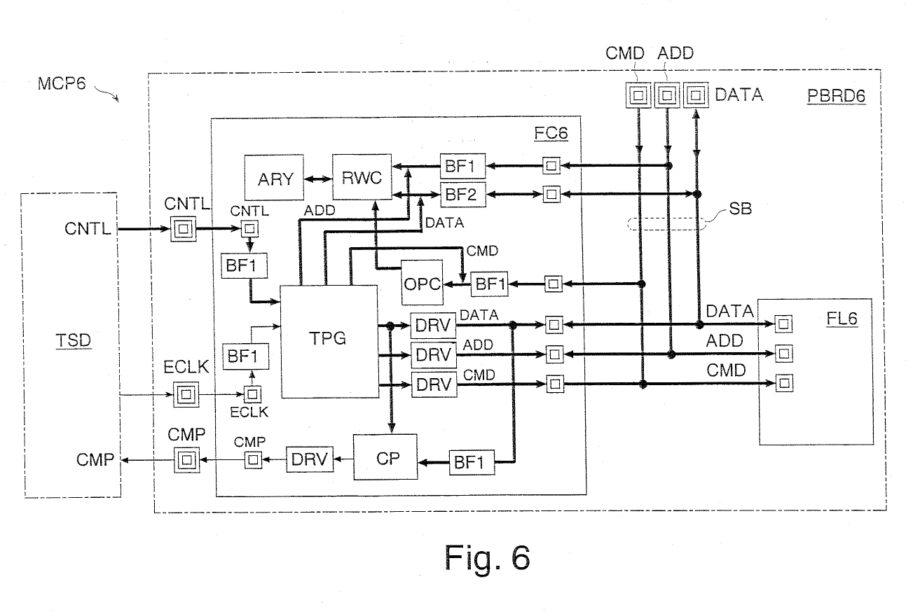

FIG. 6 shows a sixth embodiment. The same symbols are attached to the same components as those in the above embodiments to omit a detailed description thereof. In this embodiment, an FCRAM chip FC6 and a flash memory chip FL6 are mounted on a package board PBRD6 to form a multi-chip package MCP6 (system). The MCP6 is mounted, for example, in portable equipment such as a mobile phone.

The chip FC6 has, in addition to the configuration of the chip FC5 in the fifth embodiment, an external clock terminal ECLK (pad) for receiving an external clock ECLK and the buffer BF1. The external clock ECLK is input into the test pattern generator TPG. The test pattern generator TPG generates test patterns in synchronization with the external clock ECLK. That is, the frequency (generation timing) of test patterns is changed in accordance with the frequency of the external clock ECLK.

The chip FL6 is a clock asynchronous NOR type flash memory. Thus, the test pattern generator TPG generates no clock CLK and no driver DRV or pad for clock CLK is formed on the chip FC6. Otherwise, the chip FC 6 is the same as the chip FC5 in the fifth embodiment.

The package board PBRD6 is the same as the package board PBRD5 in the fifth embodiment except that an external clock terminal ECLK (an external input terminal formed from a lead, bump or the like) is provided and no external terminal or wiring for clock signal CLK is formed.

In the present embodiment, like the fifth embodiment, in a test after manufacturing the MCP6, an operation test is carried out by connecting the testing apparatus TSD to the MCP6. At this time, the testing apparatus to test the MCP6 outputs, together with a test control signal CNTL, an external clock ECLK having a predetermined frequency to the MCP6. Then, test patterns in synchronization with the external clock ECLK are output.

Also in the sixth embodiment, as described above, an effect similar to that of the above embodiments can be obtained. Further, in the present embodiment, test patterns having a desired frequency can be generated and therefore, the chips FC6 and FL6 can be tested more in detail.

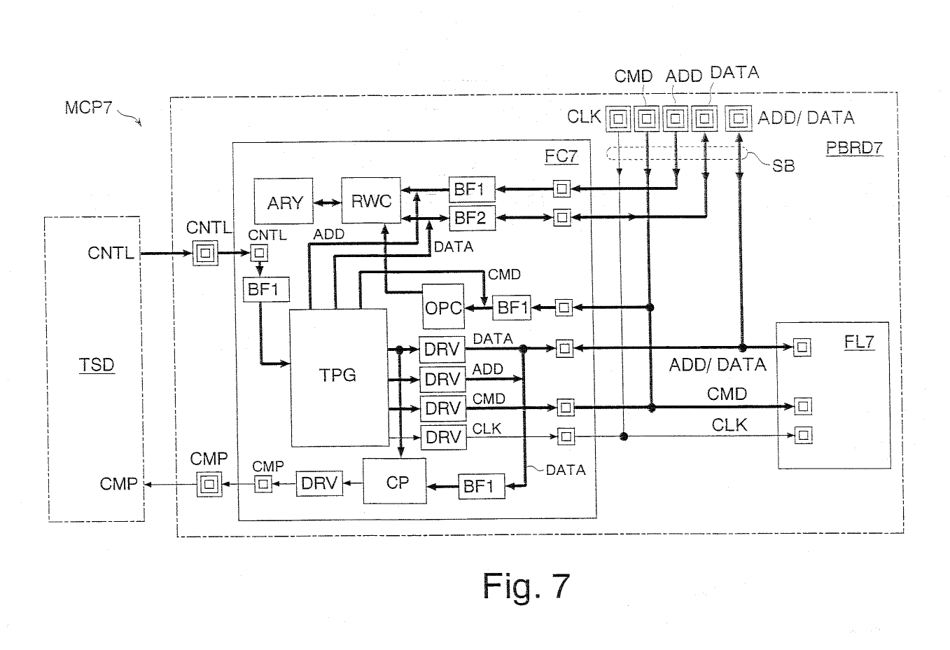

FIG. 7 shows a seventh embodiment. The same symbols are attached to the same components as those in the above embodiments to omit a detailed description thereof. In this embodiment, an FCRAM chip FC7 and a flash memory chip FL7 are mounted on a package board PBRD7 to form a multi-chip package MCP7 (system). The MCP7 is mounted, for example, in portable equipment such as a mobile phone.

The chip FC7 in this embodiment receives addresses ADD and data DATA by means of a common terminal. Thus, a system bus SB formed on the package board PBRD7 has a signal line ADD/DATA common to addresses ADD and data DATA. Also, the package board PBRD7 has an address terminal ADD and a data terminal DATA dedicated to accessing the chip FC7 and an address/data terminal ADD/DATA dedicated to accessing the chip FL7. Otherwise, the package board PBRD7 is the same as the package board PBRD5 in the fifth embodiment. A pad common to common to addresses ADD and data DATA is formed on the chip FC7 to output test patterns. Otherwise, the chip FC7 is the same as the chip FC5 in the fifth embodiment. Also in the seventh embodiment, as described above, an effect similar to that of the above embodiments can be obtained.

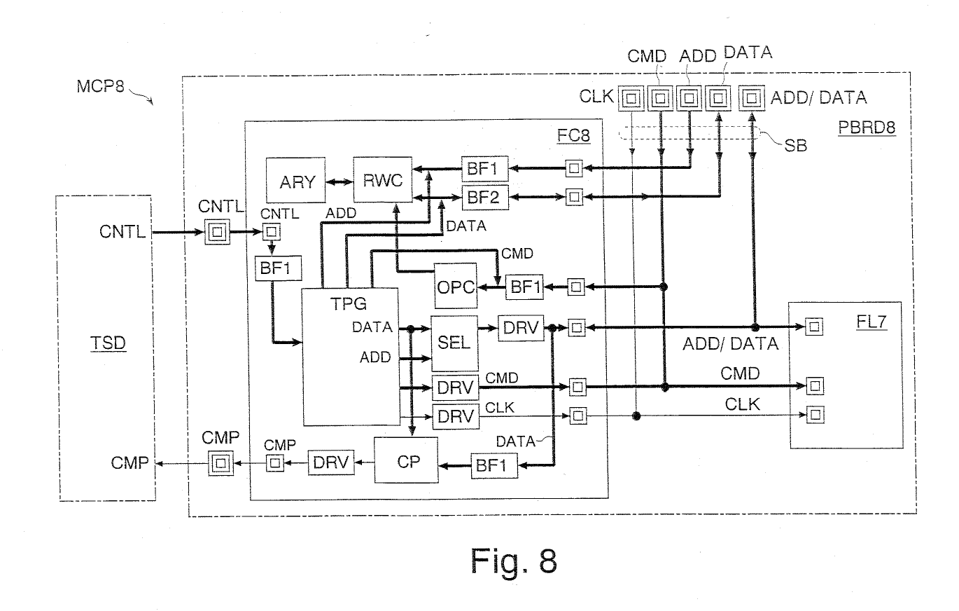

FIG. 8 shows an eighth embodiment. The same symbols are attached to the same components as those in the above embodiments to omit a detailed description thereof. In this embodiment, an FCRAM chip FC8 and the flash memory chip FL7 are mounted on a package board PBRD8 to form a multi-chip package MCP8 (system). The MCP8 is mounted, for example, in portable equipment such as a mobile phone.

The chip FC8 in this embodiment has a selector SEL to supply addresses ADD and data DATA output from the test pattern generator TPG to a common driver DRV without collision. Otherwise, the chip FC8 is the same as the chip FC7 in the seventh embodiment. The package board PBRD8 is the same as the package board PBRD7 in the seventh embodiment except that a mounting area of the chip FC8 is made smaller than that in the seventh embodiment.

Also in the eighth embodiment, as described above, an effect similar to that of the above embodiments can be obtained. Further, in the present embodiment, the number of drivers DRV of the chip FC8 can be reduced and therefore, it becomes possible to decrease the chip size of the chip FC8 and the size of the MCP8 (package board PBRD8).

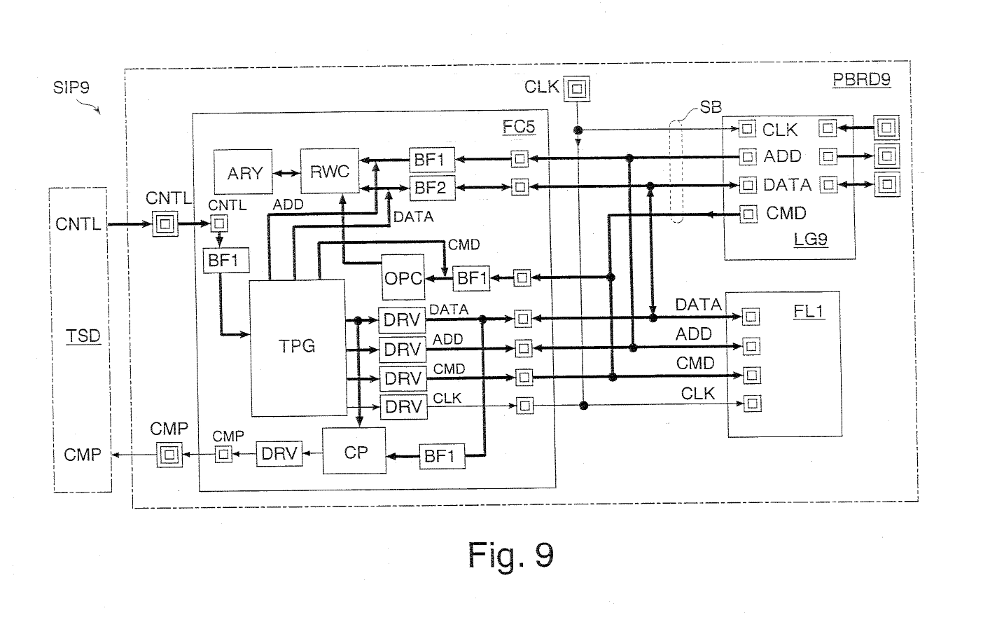

FIG. 9 shows a ninth embodiment. The same symbols are attached to the same components as those in the above embodiments to omit a detailed description thereof. In this embodiment, the FCRAM chip FC5, the flash memory chip FL1, and a logic chip LG9 are mounted on a package board PBRD9 to form a system in package SiP9 (system). The SiP9 is mounted, for example, in portable equipment such as a mobile phone.

The logic chip LG9 accesses the chip FC5 or FL1 according to instructions from outside the SiP9 during operation of portable equipment. The logic chip LG9 is in charge of exchanging signals between the SiP9 and an external system controller. Thus, no external terminal for the system bus SB is formed on the package board PBRD9 except an external terminal for the clock terminal CLK.

The system bus SB through which test patterns (DATA, ADD, CMD, and CLK) output from the chip FC5 are transmitted is connected to the logic chip LG9. That is, test patterns are supplied to the chip FC1 using the control signal line (system bus SB) transmitting a control signal output from the logic chip LG9 to access the chip FL1.

In the present embodiment, like the fifth embodiment, in a test after manufacturing the SiP9, an operation test is carried out by connecting the testing apparatus TSD to the SiP9. At this time, external terminals of the package board PBRD9 are set in an open position except the test control terminal CNTL and the test result terminal CMP.

Also in the ninth embodiment, as described above, an effect similar to that of the above embodiments can be obtained. Further, in the present embodiment, even when no external terminal exists on the package board PBRD9 to access the chip FC5 or FL1, the chips FC5 and FL1 can be tested using minimum test terminals. By supplying test patterns to the chip FL1 using the system bus SB through which control signals of the logic chip LG9 are transmitted, the number of signal lines formed on the package board PBRD9 can be reduced and the board size can be reduced. As a result, system costs can be reduced. Since the system bus SB is used to supply test patterns to the chip FL1, an interconnection test of the system bus SB can be carried out when testing the chip FL1.

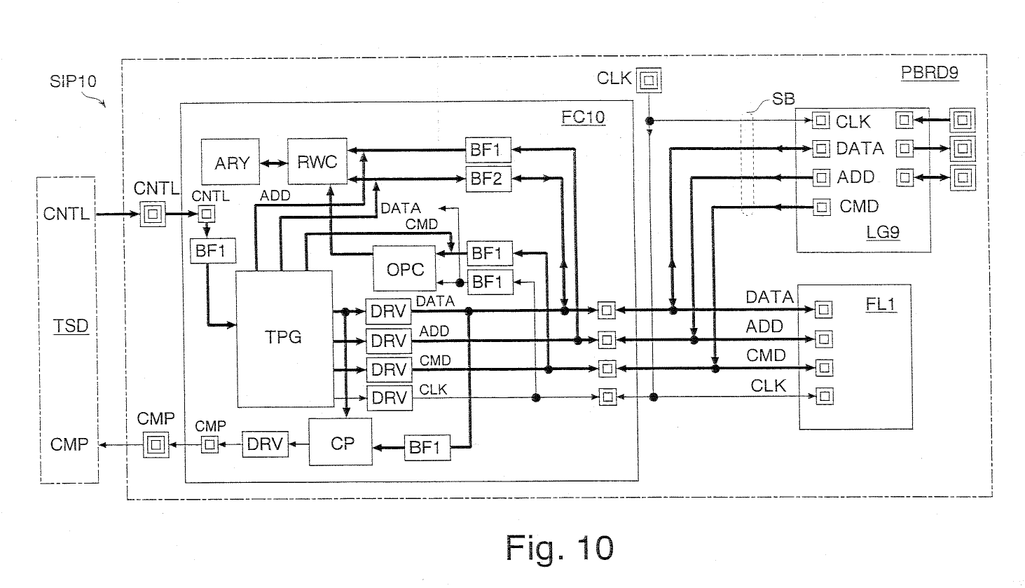

FIG. 10 shows a tenth embodiment. The same symbols are attached to the same components as those in the above embodiments to omit a detailed description thereof. In this embodiment, an FCRAM chip FC10, the flash memory chip FL1, and the logic chip LG9 are mounted on the package board PBRD9 to form a system in package SiP10 (system). The SiP10 is mounted, for example, in portable equipment such as a mobile phone.

The chip FC10 is a clock synchronous FCRAM. Thus, a control circuit such as an operation control circuit OPC receives a clock CLK via the buffer BF1. Also, address terminals ADD, data terminals DATA, and command terminals CMD of the chips FC10 and FL1 are fully compatible. Thus, an address terminal ADD, a data terminal DATA, and a command terminal CMD common to the chips FC10 and FL1 are formed on the chip FC10. That is, the data terminal DATA, address terminal ADD, and command terminal CMD that output test patterns also serve as input terminals for receiving input signals DATA, ADD, and CMD supplied to access the memory cell array ARY. Otherwise, the chip FC10 is the same as the chip FC5 in the fifth embodiment.

Also in the tenth embodiment, as described above, an effect similar to that of the above embodiments can be obtained. Further, in the present embodiment, the chip size of the chip FC10 can be decreased by forming dual-purpose terminals.

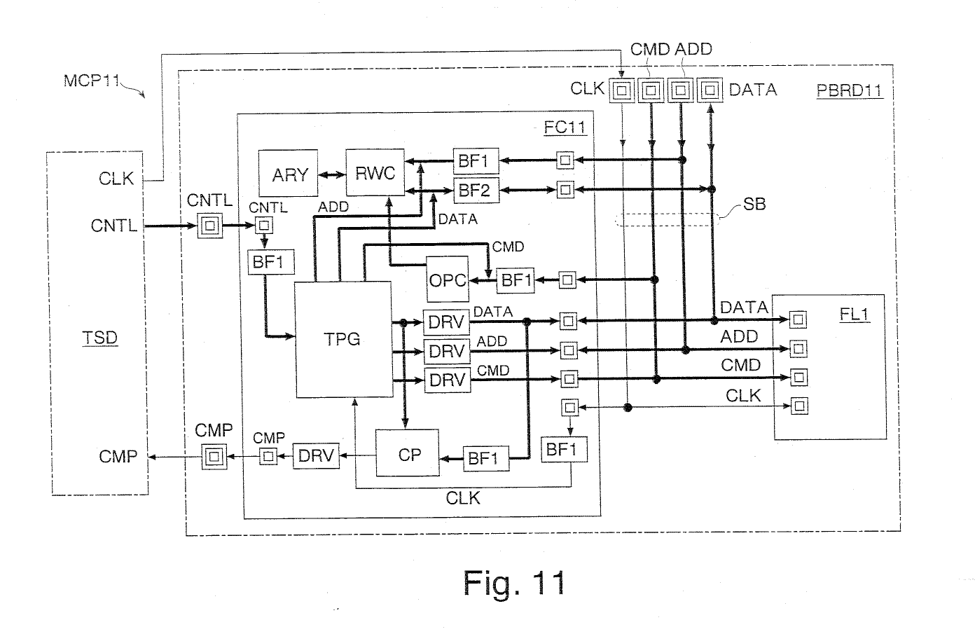

FIG. 11 shows an eleventh embodiment. The same symbols are attached to the same components as those in the above embodiments to omit a detailed description thereof. In this embodiment, an FCRAM chip FC11 and a flash memory chip FL11 are mounted on the package board PBRD11 to form a multi-chip package MCP11 (system). The MCP11 is mounted, for example, in portable equipment such as a mobile phone.

A test pattern generator TPG of the chip FC11 operates in synchronization with a clock CLK. Thus, the chip FC11 has a pad for receiving the clock CLK from outside the package board PBRD11 and the buffer BF1. The test pattern generator TPG generates no clock CLK and the chip FC11 has neither driver DRY nor pad formed thereon for outputting the clock CLK to the chip FL1. Otherwise, the chip FC11 is the same as the chip FC5 in the fifth embodiment.

In the present embodiment, the clock CLK to test the chip FL1 is supplied from the testing apparatus TSD to the MCP11. Thus, the clock frequency for a test can freely be changed. The test pattern generator TPG generates test patterns in synchronization with the clock CLK. Therefore, the chip FC11 can be tested by the clock CLK having a desired frequency output from the testing apparatus TSD. Also in the eleventh embodiment, as described above, an effect similar to that of the above embodiments can be obtained.

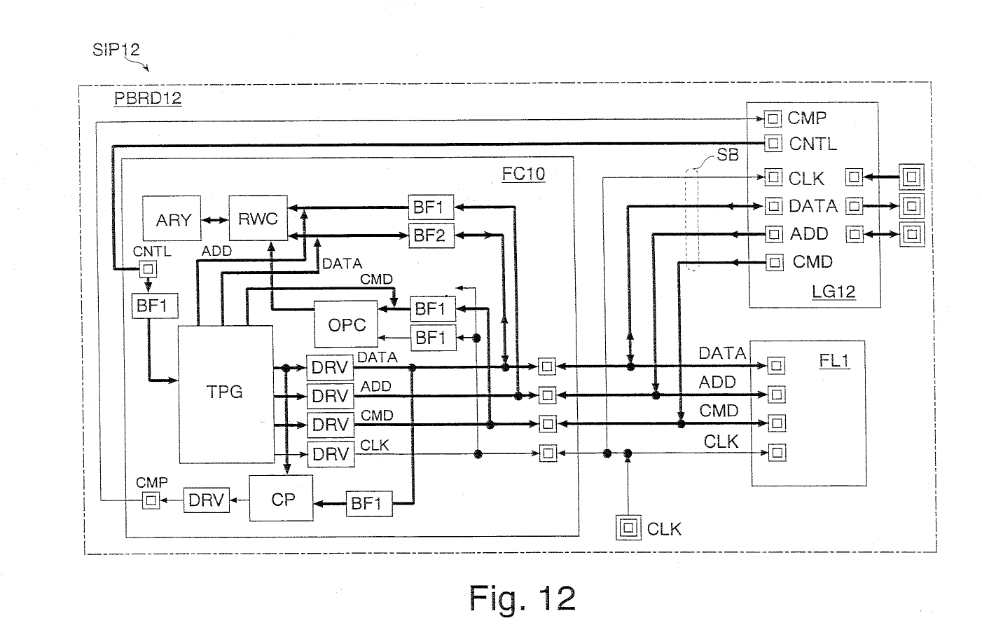

FIG. 12 shows a twelfth embodiment. The same symbols are attached to the same components as those in the above embodiments to omit a detailed description thereof. In this embodiment, the FCRAM chip FC10, the flash memory chip FL1, and a logic chip LG12 are mounted on a package board PBRD12 to form a system in package SiP12 (system). The SiP12 is mounted, for example, in portable equipment such as a mobile phone.

The logic chip LG12 includes, for example, a CPU (not shown). The logic chip LG12 has a pad for outputting addresses ADD and commands CMD, that for receiving clocks CLK, and that for inputting/outputting data DATA. The logic chip LG12 also has a pad (logic-test control output terminal) for outputting test control signals CNTL and a pad (logic-test result input terminal) for receiving test result signals CMP. That is, the logic chip LG12 has a function of the testing apparatus TSD shown in the third embodiment or the like. The package board PBRD12 has external terminals (leads or bumps) for inputting or outputting control signals and the like with respect to a clock terminal CLK (a lead or bump) and the logic chip 12.

In the present embodiment, when an activation signal to test the chip FC10 or FL1 is received from outside the SiP12, the chip LG12 outputs a test control signal CNTL. The chip LG12 determines whether chips FC10 and FL1 operate in accordance with a test result signal CMP received from the chip FC10 and outputs a determination result of the SiP12. A test of the SiP12 is carried out using an LSI tester for logic (logic tester) to test the logic chip LG12.

Also in the twelfth embodiment, as described above, an effect similar to that of the above embodiments can be obtained. Further, in the present embodiment, by forming in the logic chip LG12 a function to determine a test result of the chips FC10 and FL1 in accordance with a test result signal CMP after a test control signal CNTL being output, the chips FC10 and FL1 can be tested by causing the logic chip LG12 to operate for a testing apparatus. If, for example, a test of the logic chip LG12 is carried out using a logic tester, the SiP12 can be tested only by the logic tester without using a memory tester. Since there is no need to use a plurality of testers (such as a memory tester and a logic tester) to test the SiP12, test costs can be reduced.

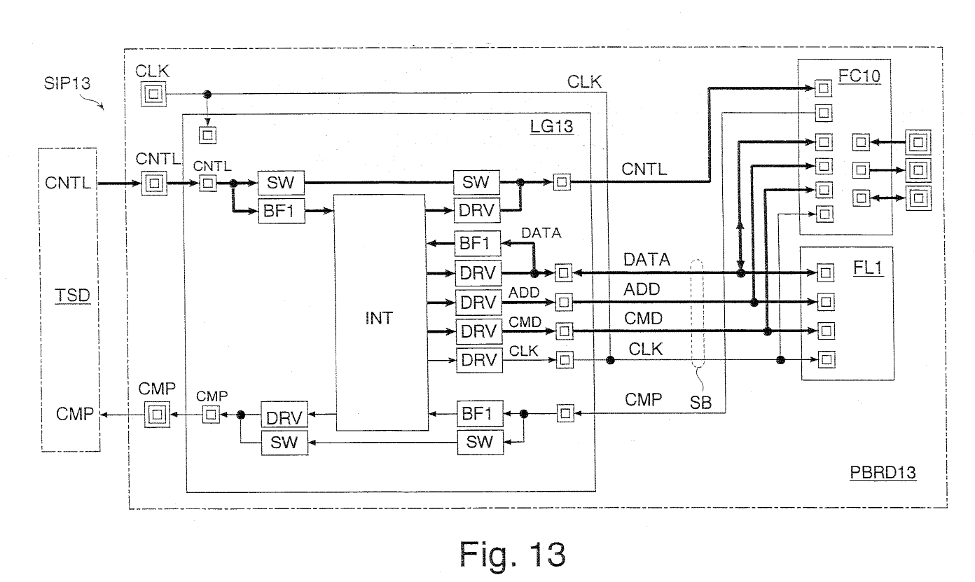

FIG. 13 shows a thirteenth embodiment. The same symbols are attached to the same components as those in the above embodiments to omit a detailed description thereof. In this embodiment, the FCRAM chip FC10, the flash memory chip FL1, and a logic chip LG13 are mounted on a package board PBRD13 to form a system in package SiP13 (system). The SiP13 is mounted, for example, in portable equipment such as a mobile phone.

The logic chip LG13 has an internal circuit INT such as a CPU core and a plurality of pads for inputting/outputting signals into/from the internal circuit INT. A predetermined number (two in FIG. 13) of pads among pads for receiving signals are connected to the buffer BF1 and the switch circuit SW for supplying signals to the internal circuit INT. A predetermined number (two in FIG. 13) of pads among pads for outputting signals are connected to the driver DRV and the switch circuit SW for driving signals output from the internal circuit INT. A pair of switch circuits SW connected to a pad for receiving signals and that for outputting signals is mutually connected.

A test result signal CMP output from the chip FC10 is supplied to the external output terminal (a lead or bump) of the package board PBRD13 via the pad (logic-test result input terminal) of the logic chip LG13, a pair of switch circuits SW, and the pad (logic-test result output terminal). A test control signal CNTL received by the external input terminal of the package board PBRD13 is supplied to the chip FC10 via the pad (logic-test control input terminal) of the logic chip LG13, a pair of switch circuits SW, and the pad (logic-test control output terminal).

In the present embodiment, when the logic chip LG13 is in bypass mode to test the chips FC10 and FL1 (when the internal circuit INT of the logic chip LG13 does not operate), the switch circuits SW are turned on and a test control signal CNTL output from the testing apparatus TSD passes through the logic chip LG13 via the switch circuits SW before being supplied to the chip FC10. Similarly, a test result signal CMP output from the chip FC10 passes through the logic chip LG13 via the switch circuits SW before being supplied to the testing apparatus TSD. The logic chip LG13 is held in a standby state in bypass mode and does not operate. Thus, the logic chip LG13 does not output addresses ADD, commands CMD and the like.

When the logic chip LG13 is in normal operation mode, in test mode to test the logic chip LG13 itself, or being used by a different system, the switch circuits SW are turned off and an input terminal and an output terminal of the signals CNTL and CMP allow input and output of signals related to operations of the internal circuit INT of the logic chip LG13 respectively. That is, the input terminal and output terminal of the signals CNTL and CMP are dual-purpose terminals functioning not only as terminals to test the chips FC10 and FL1, but also as terminals for the logic chip LG13.

As has been described above, a pair of switch circuits SW and the buffer BF1 and driver DRV corresponding to these switch circuits SW operate as a selector to connect the test control signal line CNTL and test result signal line CMP on the package board PBRD13 to external terminals (leads or bumps) of the package board PBRD13 when at least one of the chips FC10 and FL1 is tested and to connect the test control signal line CNTL and test result signal line CMP on the package board PBRD13 to the internal circuit INT when the internal circuit INT of the logic chip LG13 operates.

Also in the thirteenth embodiment, as described above, an effect similar to that of the above embodiments can be obtained. Further, in the present embodiment, by forming dual-purpose terminals that can input and output the test control signal CNTL and test result signal CMP on the logic chip LG13, the test control signal CNTL and test result signal CMP can be input/output not only into/from the logic chip LG13, but also with respect to outside the SiP13. Therefore, an optimal test in accordance with a test environment of the user who develops the SiP13 can be carried out. More specifically, for example, if the user has only a simple testing apparatus, the chips FC10 and FL1 can be tested using the logic chip LG13. If the user has the testing apparatus TSD such as an LSI tester, the chips FC10 and FL1 can be tested using the testing apparatus TSD. Further, if the logic chip LG13 is mounted in a different system, the test result input terminal CMP and the test result output terminal CNTL of the logic chip LG13 can be used as terminals of a different function.

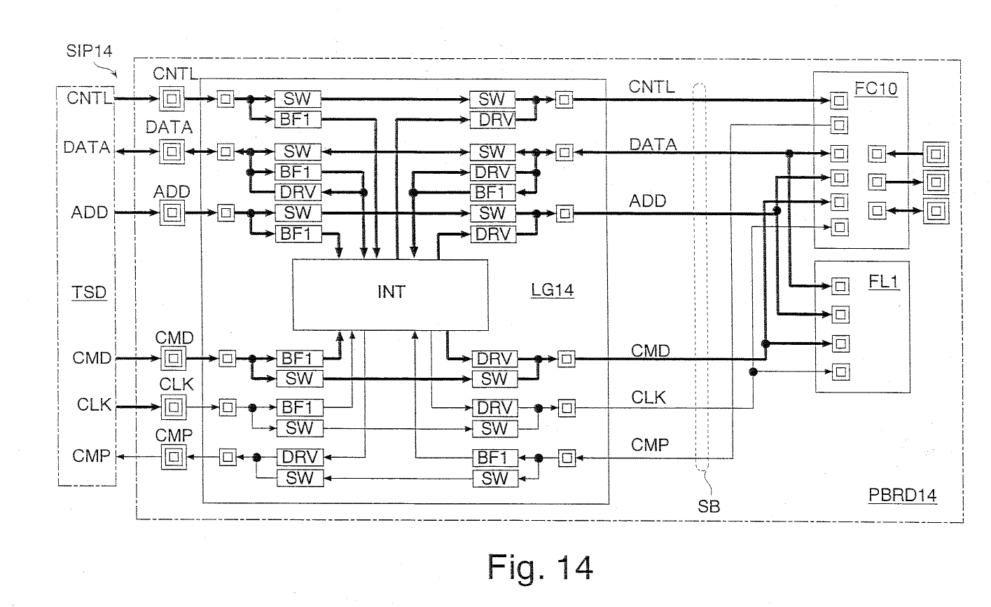

FIG. 14 shows a fourteenth embodiment. The same symbols are attached to the same components as those in the above embodiments to omit a detailed description thereof. In this embodiment, the FCRAM chip FC10, the flash memory chip FL1, and a logic chip LG14 are mounted on a package board PBRD14 to form a system in package SiP14 (system). The SiP14 is mounted, for example, in portable equipment such as a mobile phone.

The logic chip LG14 has an internal circuit INT such as a CPU core and a plurality of pads for inputting/outputting signals into/from the internal circuit INT. A predetermined number of pads among pads for receiving signals are connected to the buffer BF1 for supplying signals to the internal circuit INT and the switch circuit SW. A predetermined number of pads among pads for outputting signals are connected to the driver DRV for driving signals output from the internal circuit INT and the switch circuit SW. A predetermined number of pads among pads for inputting/outputting signals are connected to the buffer BF1 for supplying signals to the internal circuit INT, the driver DRV for driving signals output from the internal circuit INT, and the internal circuit switch circuit SW. A pair of switch circuits SW connected to a pad for receiving signals and that for outputting signals is mutually connected.

In the present embodiment, when the logic chip LG14 is in bypass mode to test the chips FC10 and FL1, the switch circuits SW are turned on and signals output from the testing apparatus TSD to pads (CNTL: logic-test control input terminal; DATA, ADD, CMD, CLK: logic external terminals) of the logic chip LG14 to carry out a test pass through the logic chip LG14 before being output to the system bus SB via pads (CNTL: logic-test control output terminal; DATA, ADD, CMD, CLK: logic internal terminals). Signals supplied to pads (CMP: logic-test result input terminal; DATA: logic internal terminal) of the logic chip LG14 via the system bus SB pass through the logic chip LG14 before being output to the testing apparatus TSD via pads (CMP: logic-test result output terminal; DATA: logic external terminal). Thus, the testing apparatus TSD can directly supply a test control signal CNTL to the chip FC10 and directly receive a test result signal CMP from the chip FC10.

The testing apparatus TSD can, in addition to the test control signal CNTL and test result signal CMP, supply addresses ADD, data DATA, commands CMD, and clocks CLK to the chips FC10 and FL1 via the logic chip LG14, and receive data DATA from the chips FC10 and FL1.

When the logic chip LG14 is in normal operation mode or in test mode to test the logic chip LG14 itself, the switch circuits SW are turned off and input terminals and output terminals corresponding to the switch circuits SW allow input and output of signals related to operations of the internal circuit INT of the logic chip LG14 respectively. That is, these terminals are, like in the thirteenth embodiment, dual-purpose terminals.

As has been described above, a pair of switch circuits SW and the buffer BF1 and driver DRV corresponding to these switch circuits SW operate as a selector to connect the system bus SB (system signal line) to external terminals (leads or bumps) of the package board PBRD14 when at least one of the chips FC10 and FL1 is tested and to connect the system bus SB to the internal circuit INT when the internal circuit INT of the logic chip LG14 operates.

Also in the fourteenth embodiment, as described above, an effect similar to that of the above embodiments can be obtained. Further, in the present embodiment, the testing apparatus TSD in bypass mode can not only test the chips FC10 and FL1 by causing the test pattern generator TPG of the chip FC10 to operate using signals CNTL and CMP, but also directly access the chips FC10 and FL1. Thus, for example, good products can be selected using the signals CNTL and CMP by a simple testing apparatus TSD in a test after assembling the SiP14. After assembling the SiP14, programs or the like can be written into the flash memory chip FL1 by a simple testing apparatus TSD such as a ROM writer. Further, when the SiP14 fails, a detailed evaluation of the SiP14 can be performed by a testing apparatus TSD such as a memory tester using addresses ADD, data DATA, commands CMD, and clocks CLK.

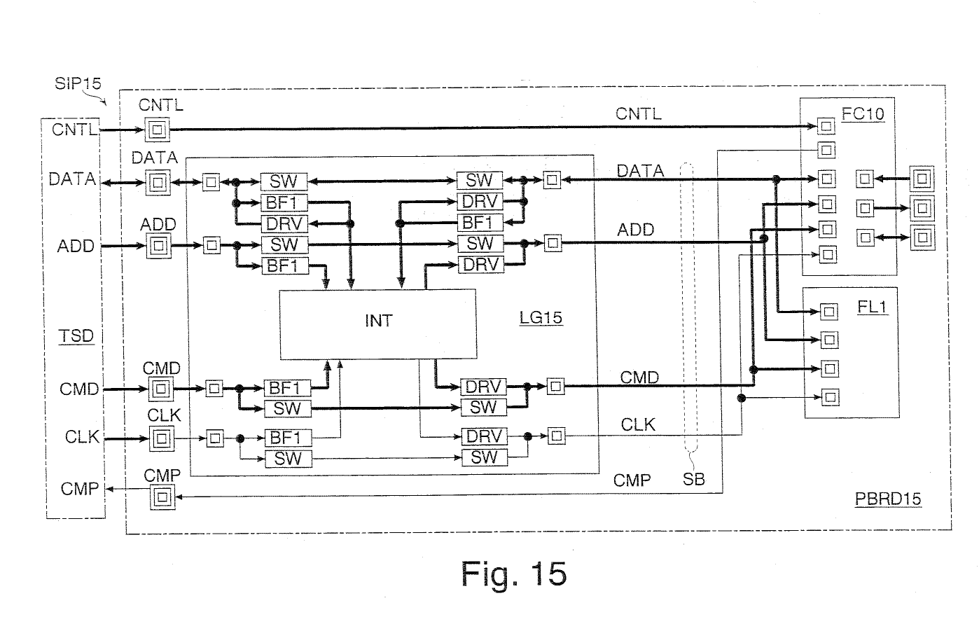

FIG. 15 shows a fifteenth embodiment. The same symbols are attached to the same components as those in the above embodiments to omit a detailed description thereof. In this embodiment, the FCRAM chip FC10, the flash memory chip FL1, and a logic chip LG15 are mounted on a package board PBRD15 to form a system in package SiP15 (system). The SiP15 is mounted, for example, in portable equipment such as a mobile phone.

In this embodiment, a test control signal line CNTL and a test result signal line CMP are directly wired between external terminals of the package board PBRD15 and the chips FC10 and FL1 without passing through the logic chip LG15. External terminals DATA, ADD, CMD, and CLK of the package board PBRD15 are connected to the chips FC10 and FL1 via the logic chip LG15. Otherwise, the configuration is the same as the fourteenth embodiment. Also in the fifteenth embodiment, as described above, an effect similar to that of the above embodiments can be obtained.

The above embodiments have described examples in which FCRAM chips and flash memory chips are arranged side by side on the package boards PBRD1 to PBRD15. However, the present invention is not limited to such embodiments. For example, an FCRAM chip and a flash memory chip may be arranged on a package board by stacking them. Alternatively, a package board may be arranged between a stacked FCRAM chip and flash memory chip.

FCRAM chips and flash memory chips mounted in a multi-chip package or a system in package may be of clock synchronous type or clock asynchronous type. Chips to be mounted in a multi-chip package or a system in package are not limited to FCRAM chips and flash memory chips. For example, pseudo SRAM chips, DRAM chips, EEPROM chips, or ferroelectric memory chips may also be mounted.

Test patterns (at least one of ADD, DATA, and CMD) of the FCRAM chip and flash memory chip generated by the test pattern generator TPG may be output to a common signal line, as shown in the seventh embodiment. In this case, the number of signal lines wired on the chip FC1 can be reduced.

In the fourth to ninth and eleventh embodiments, a pad formed on the FCRAM chip to access the FCRAM chip from outside the package board and a pad formed on the FCRAM chip to output test patterns may be made common like in the third embodiment.

In the seventh and eighth embodiments, examples in which the present invention is applied to a multi-chip package on which the FCRAM chip FC7 having an address terminal ADD and a data terminal DATA and a flash memory chip FL7 having a common terminal ADD/DATA of addresses and data are mounted have been described. If, on the other hand, both the FCRAM chip and flash memory chip each have a common terminal ADD/DATA of addresses and data, address signals ADD and data signals DATA are transmitted to the FCRAM chip by connecting the common terminal ADD/DATA of the FCRAM chip shown in FIG. 7 and FIG. 8 to the buffers BF1 and BF2. In this case, the address terminal ADD and data terminal DATA of the FCRAM chip and the multi-chip package are no longer needed. As a result, the chip size of the FCRAM chip can be decreased and ultimately the size of the multi-chip package can be decreased.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A semiconductor memory, comprising:
a memory cell array;
a test pattern generator having nonvolatile logic to generate a plurality of test patterns to test said memory cell array and a different type of memory chip mounted in a same package as said memory cell array; and
a plurality of external output terminals writing said test patterns into said memory chip.

2. The semiconductor memory according to claim 1, further comprising:
an external input terminal receiving the test pattern read from said memory chip;
a comparator comparing the test pattern generated by said test pattern generator and the test pattern received by said external input terminal; and
a test result terminal outputting a comparison result by said comparator.

3. The semiconductor memory according to claim 2, wherein
said test result terminal is a dedicated terminal that outputs only said comparison result.

4. The semiconductor memory according to claim 2, further comprising:
a test control terminal receiving a test control signal to control operations of said pattern generator.

5. The semiconductor memory according to claim 4, wherein
said test control terminal is a dedicated terminal that receives only said test control signal.

6. The semiconductor memory according to claim 1, wherein
at least some of said external output terminals serve also as an input terminal that receives an input signal supplied to access said memory cell array.

7. A system comprising: a first memory chip; and a second memory chip of a different type from that of the first memory chip mounted in one package, wherein
said first memory chip, includes:
a memory cell array;
a test pattern generator having nonvolatile logic to generate a plurality of test patterns to test said memory cell array and the second memory chip; and
a plurality of external output terminals writing said test patterns into said second memory chip.

8. The system according to claim 7, further comprising:
an external input terminal receiving data output from said second memory chip, a comparator comparing data generated by said test pattern generator and that received by said external input terminal, and a test result terminal outputting a comparison result by said comparator, each formed on said first memory chip, and
a system-test result terminal connected to said test result terminal to output said comparison result to an outside of the system.

9. The system according to claim 7, further comprising:
a test control terminal formed on said first memory chip to receive a test control signal to control operations of said test pattern generator; and
a system-test control terminal connected to said test control terminal to receive said test control signal from an outside of the system.

10. The system according to claim 7, further comprising:
a logic chip to access said first memory chip and second memory chip, and
a system bus mutually connecting said first memory chip, second memory chip, and said logic chip, wherein
said external output terminals of said first memory chip are connected to said system bus to transmit said test patterns to said second memory chip via said system bus.

11. The system according to claim 10, wherein
said system bus includes a control signal line through which a control signal output from said logic chip is transmitted to access said first and second memory chips, and
at least some of said external output terminals are connected to said control signal line.

12. The system according to claim 10, further comprising:
an external input terminal receiving data output from said second memory chip, a comparator comparing data generated by said test pattern generator and data received by said external input terminal, and a test result terminal outputting a comparison result by said comparator, each formed on said first memory chip, and
a logic-test result input terminal formed on said logic chip and connected to said test result terminal to receive said comparison result.

13. The system according to claim 12, wherein
said logic chip includes:
a logic-test result output terminal outputting said comparison result received by said logic-test result input terminal to an outside of the system; and
a selector outputting said comparison result received by said logic-test result input terminal to said logic-test result output terminal when an internal circuit of said logic chip does not operate and at least one of said first and second memory chips is tested, and outputting a signal received by said logic-test result input terminal to the internal circuit of said logic chip when the internal circuit of said logic chip operates.

14. The system according to claim 10, further comprising:
a test control input terminal formed on said first memory chip to receive a test control signal to control operations of said test pattern generator; and
a logic-test control output terminal formed on said logic chip and connected to said test control input terminal to output said test control signal.

15. The system according to claim 14, wherein,
said logic chip includes:
a logic-test control input terminal receiving said test control signal to be output to said logic-test control output terminal from an outside of the system; and
a selector outputting said test control signal received by said logic-test control input terminal to said logic-test control output terminal when an internal circuit of said logic chip does not operate and at least one of said first and second memory chips is tested, and outputting a signal received by said logic-test control input terminal to the internal circuit of said logic chip when the internal circuit of said logic chip operates.

16. The system according to claim 10, wherein
said system bus includes a system signal line through which a signal output/input from/into said logic chip to access said first and second memory chips is transmitted and which is closed within the system, and wherein
said logic chip includes:
a logic internal terminal to which said system signal line is connected;
a logic external terminal connecting said logic internal terminal to an outside of the system; and
a selector connecting said system signal line to said logic external terminal when an internal circuit of said logic chip does not operate and at least one of said first and second memory chips is tested, and connecting said system signal line to said internal circuit when the internal circuit of said logic chip operates.

17. The system according to claim 7, wherein
said first memory chip is a memory chip having said memory cell array constituted by dynamic memory cells, and
said second memory chip is a flash memory chip.

18. A testing method for a system in which a first memory chip and a second memory chip of a different type from the first memory chip are mounted in one package; comprising:
generating test pattern for said second memory chip in said first memory chip;
writing the generated test pattern into said second memory chip;
reading the written test pattern from said second memory chip;
comparing the written test pattern and the read test pattern in said first memory chip; and
outputting a comparison result from said first memory chip.

19. The testing method for a system according to claim 18, further comprising:
receiving a test control signal by said first memory chip; and
determining said test pattern generated to be written into said second memory chip in accordance with said test control signal in said first memory chip.
